(19) United States
(12) Patent Application Publication
(10) Pub. No.: US 2010/0230356 A1
(43) Pub. Date: Sep. 16, 2010

(54) COMPOSITIONS FOR FLUID REHABILITATION AND APPARATUSES AND METHODS FOR USING SAME

(75) Inventor: Hao Chhoa, Vancouver (CA)

Correspondence Address: MARTIN D. MOYNIHAN d/b/a PRTSI, INC., P.O. BOX 16446, ARLINGTON, VA, 22215, US

(73) Assignee: Environtech Services Ltd.

(21) Appl. No.: 12/665,059

(22) PCT Filed: Jun. 17, 2008
(86) PCT No.: PCT/IB08/52380

§ 371 Date: May 20, 2010

Related U.S. Application Data
(60) Provisional application No. 60/929,188, filed on Jun. 18, 2007.

(51) Int. Cl. B01J 29/035; B01D 15/00; B01D 35/06; B01D 36/00

(52) U.S. Cl. 210/663; 210/263; 210/259; 210/223; 210/660; 502/63

(57) ABSTRACT

A composition of matter for rehabilitating a fluidic substance, comprising: a) at least one decolorizing ingredient constituting at least 58% by volume of the whole composition; and, b) at least one acidity reducing ingredient constituting at least 5% by volume of the whole composition.

### FIELD OF THE INVENTION

The present invention relates to compositions of matter for rehabilitating fluidic substances and methods and apparatuses for employing the compositions of matter.

### BACKGROUND OF THE INVENTION

Present and future transformers require high quality and high purity insulating oils at the point of use. The ever increasing voltage and rating levels of modern transformers and related electrical apparatuses result in greater electrical stress in insulating materials and fluids. To handle these greater stresses, oils with better dielectric qualities are required. Also lower residual water content in insulating fluids and material must be maintained. Therefore, the treatment and condition of oil throughout the process becomes critical to the efficiency and lifespan of industrial transformers.

Typically, petroleum products used for industrial purposes are simply disposed of after use. In the United States alone, over 1.7 billion gallons of lubricating, hydraulic, and other petroleum products are disposed of each year, Napthenics Magazine, June 1996. Alternatively today, these petroleum products are expensively and inefficiently rehabilitated. For example, to rehabilitate 50,000 liters of oil, 5,000 Kg of adsorbents are needed which subsequently creates 8,000 Kg of oil saturated adsorbents for disposal. Without proper disposal, this amount of saturated adsorbents can contaminate 150,000 m² of drinking water.

Attempts have been made to improve the efficiency of petroleum fluid rehabilitation applying Fuller's Earth to the fluid after drying, for example using heat and/or a chemical wash, however these methods still produce less than desirable amounts of secondary pollution.

### SUMMARY OF THE INVENTION

An aspect of some embodiments of the invention relates to providing a plurality of compositions of matter adapted for the rehabilitation of at least one fluidic substance. In some embodiments of the invention, the fluidic substance is petroleum based. In some embodiments of the invention, the fluidic substance is a refrigerant and/or coolant. In some embodiments of the invention, the fluidic substance is de-ionized water and/or some other non-conducting fluid. Ingredients of the compositions of matter are layered and/or are adapted to be applied sequentially to the fluidic substance being rehabilitated, in some embodiments of the invention. Optionally, the ingredients of the compositions of matter are mixed. In some embodiments of the invention, ingredients include Fuller's Earth, granular active carbon, 5A molecular sieve beads, a sulfur scavenger such as Alcan Actiguard S, a desiccant such as Alcan Actiguard H₂O, and/or an adsorbent designed to remove sulfur compounds, such as NSR-116 Sulfur Sorber Catalyst (“Sulfurcat”), distributed by Sepcor, Inc., Houston, Tex.

In an embodiment of the invention, selected ingredients are presented (e.g. the fluidic substance flows through the ingredients) to the fluidic substance being rehabilitated in a specific order, for example granular activated carbon preceding Actiguard S in the direction of flow of the fluidic substance. In some embodiments of the invention, the ingredients are layered in a vessel in the specific order wherein the fluidic substance is passed through the vessel, and therefore the layers, in a desired sequence of exposure to the layers of ingredients. Optionally, the vessel is a cylindrical rod. Additionally, alternatively and/or optionally, the vessel is porous.

In some embodiments of the invention, the proportion of the total amount and/or selection of ingredients are dependent on the type of fluidic substance being rehabilitated. Type is determined, for example, by ISO Viscosity Grade and/or the kind of fluid (e.g. lubricating, hydraulic, and/or other petroleum products, water, refrigerant and/or coolant fluids, etc.) and/or the pH of the fluid being rehabilitated.

An aspect of some embodiments of the invention relates to providing an apparatus for rehabilitating fluidic substances including an electro-magnetic particle filtration section and/or a universal particle filtration section and/or purification section and/or a rehabilitation section. In an embodiment of the invention, the electro-magnetic particle “filtration” section is actually comprised of at least one electromagnetic probe which, when charged, attracts metallic particles. In some embodiments of the invention, the universal particle filtration section is comprised of a conical baffle assembly provided with a filtration screen which collects particles within the screen. The filtration screen collects both metallic and non-metallic particles, in an embodiment of the invention. In some embodiments of the invention, the electro-magnetic particle “filtration” section and the universal particle filtration section are combined into one section. In some embodiments of the invention, the purification section is used for removing particulate matter, gas and/or moisture from the fluid being rehabilitated. It should be understood that the order of the electro-magnetic particle “filtration” section and the universal particle filtration section, when both are used in the apparatus, is not critical in some embodiments of the invention, allowing for either section to be used before the other but both before the rehabilitation section. In an embodiment of the invention, the purification section acts on the fluid being rehabilitated before the fluid enters the rehabilitation section.

In some embodiments of the invention, the rehabilitation section includes a composition of matter comprised of ingredients which are selected and/or are arranged for rehabilitation of a specific fluidic substance. In an embodiment of the invention, the rehabilitation section is comprised of at least one vessel with at least one of the ingredients situated therein wherein the fluidic substance being rehabilitated flows into the vessel, through the at least one ingredient and/or is recirculated through the ingredients until the fluidic substance has been rehabilitated to or above a predetermined threshold, for example a threshold of quality. Optionally, the at least one ingredient is arranged in a porous, cylindrical “rehabilitation” rod.

An aspect of some embodiments of the invention relates to providing a rehabilitation rod adapted for the sequential arrangement of layers of ingredients used for rehabilitating a fluidic substance which passes through the rod. In some embodiments of the invention, the rehabilitation rod is cylindrical. In an embodiment of the invention, the rehabilitation rod is porous, adapted for flow of the fluidic substance being rehabilitated therethrough and/or through the ingredients located therein. In an embodiment of the invention, the rehabilitation rod is provided with openings at either end of a longitudinal axis. In an embodiment of the invention, the rehabilitation rod is provided with at least one opening along the outer circumference of the rod additionally, alternatively and/or optionally to openings at either end of the longitudinal axis.

In an embodiment of the invention, the length to diameter ratio of the rehabilitation rod is adapted for efficient rehabilitation of the fluidic substance. It should be understood that by modification of the length to diameter ratio, the internal volume of the rod and/or the surface area of ingredients coming into contact with the fluid being rehabilitated change. In some embodiments of the invention, the length to diameter ratio is between 2 to 1 and 13 to 1. Optionally, the length to diameter ratio is 9 to 1. Optionally, the length to diameter ratio is 6 to 1. In an embodiment of the invention, the length to diameter ratio is chosen depending on the type of fluidic substance being rehabilitated.

In an embodiment of the invention, the rehabilitation rod is constructed of a substance which does not adversely react with the fluid being rehabilitated. In embodiments a metal is used for constructing the rod, for example aluminum, carbon steel, copper or stainless steel.

An aspect of some embodiments of the invention relates to providing a universal particle filtration section, optionally with a conical baffle assembly, adapted for regulating fluid flow and/or filtering debris.

In an embodiment of the invention, the universal particle filtration section is equipped with a conical shaped baffle which also serves as a filter for removing debris from the fluid being rehabilitated. In some embodiments of the invention, the size of particles which are filtered is determined by the type of fluid being filtered, for example fluids with high ISO viscosity grades (ISO viscosity grades being one way of determining type) are filtered for particles as small as 1 micron. In some embodiments of the invention, the conical filter is provided with pores adapted for filtering out debris as small as 1 micron. In some embodiments of the invention, the conical filter is provided with pores adapted for filtering out debris as small as 0.5 microns.

In an embodiment of the invention, the conical shape of the baffle/filter is used to regulate fluid flow as it transitions from an electro-magnetic particle filtration section, to a rehabilitation section in a fluid rehabilitation apparatus. In an embodiment of the invention, the conical baffle assembly is divided into a first portion upstream of the baffle/filter and a second portion downstream of the baffle/filter. In some embodiments of the invention, the velocity of flow in the first portion is slowed as the fluid passes through the conical shaped baffle/filter. In some embodiments of the invention, the flow velocity in the second portion increases as the fluid progresses past the baffle/filter. In such an embodiment of the invention, the inlet flow rate and the outlet flow rate are the same; however, the flow velocity is different between the upstream and downstream portions.

An aspect of some embodiments of the invention relates to providing a method for rehabilitating at least one fluidic substance, the method including at least passing the fluidic substance through a plurality of ingredients, optionally arranged in layers and/or additionally or alternatively in a predefined sequence. Each layer is substantially comprised of one ingredient, in accordance with an embodiment of the invention. In exemplary embodiments of the invention, the ingredients chosen, the percentage of each ingredient used and/or their sequence are selected in accordance with the fluidic substance being rehabilitated. In some embodiments of the invention, each ingredient is selected to perform a different effect on the fluidic substance, examples including reducing acidity, as a desiccant, and/or for removing sulfur. In some embodiments of the invention, a plurality of ingredients are used to provide a cumulative effect on the fluidic substance, for example continuing to reduce acidity as the fluid passes through the plurality of layers of ingredients. In some embodiments of the invention, ingredient layers are chosen by the pH of the fluid being rehabilitated in order to maximize the reaction changes when the fluid comes into contact with the ingredients. Selected layers of ingredients are packed, optionally in a predefined sequence, into at least one vessel or container adapted for flow of the fluid therethrough, for example in a rehabilitation rod. In an embodiment of the invention, indicated percentages of ingredients used are as a percentage of the total volume of the at least one vessel. In an embodiment of the invention, the fluid being rehabilitated is passed through the at least one packed vessel at least one time in order to rehabilitate the fluid. Additionally and/or optionally, the fluid is passed through an electromagnetic filter for filtering out metallic debris. Additionally, alternatively and/or optionally, the fluid is passed through a universal filter for filtering out debris greater than a certain size.

There is thus provided in accordance with an exemplary embodiment of the invention a composition of matter for rehabilitating a fluidic substance, comprising: a) at least one decolorizing ingredient constituting at least 58% by volume of the whole composition; and, b) at least one acidity reducing ingredient constituting at least 5% by volume of the whole composition. In an embodiment of the invention, the composition of matter further comprises: c) at least one dehydrating ingredient constituting at least 5% by volume of the whole composition. Optionally, the at least one decolorizing ingredient is at least one of: i) Fuller's Earth, ii) a 5A molecular sieve or iii) granular activated carbon. Optionally, the at least one acidity reducing ingredient is at least one of: i) a composition of 83%-94% aluminum oxide, 3%-10% sodium carbonate and 3%-7% moisture, ii) Fuller's Earth, or iii) a 5A molecular sieve. Optionally, the at least one dehydrating ingredient is at least one of: i) a composition of 94-96% by weight Al₂O₃, 0.45% by weight Na₂O, 0.015% by weight Fe₂O₃, 0.020% by weight SiO₂ and 0.002% by weight TiO₂, or ii) a composition of 83%-94% aluminum oxide, 3%-10% sodium carbonate and 3%-7% moisture. Optionally, the at least one decolorizing agent is either a combination of Fuller's Earth and granular activated carbon for fluid viscosities less than or equal to ISO 15 or a combination of granular activated carbon and a 5A molecular sieve for fluid viscosities greater than ISO 15.

In an embodiment of the invention, there is provided a composition of matter comprising: i) 13% to 25% by volume of a 5A molecular sieve, ii) 5% to 10% by volume of a composition of 52%-58% Ni and 42%-48% Al₂O₃; iii) 50% to 75% by volume of granular activated carbon, and, iv) 7% to 15% by volume of a composition of 83%-94% aluminum oxide, 3%-10% sodium carbonate and 3%-7% moisture. Optionally, each ingredient forms a layer in a predefined sequence of layers i) through iv).

In an embodiment of the invention, there is provided a composition of matter comprising: i) 8% to 45% by volume of a 5A molecular sieve, ii) 50% to 85% by volume of granular activated carbon, and, iii) 5% to 7% by volume of a composition of 52%-58% Ni and 42%-48% Al₂O₃. Optionally, each ingredient forms a layer in a predefined sequence of layers i) through iii).

In an embodiment of the invention, there is provided a composition of matter comprising: i) 15% to 20% by volume of granular activated carbon, ii) 10% to 25% by volume of a composition of 83%-94% aluminum oxide, 3%-10% sodium carbonate and 3%-7% moisture iii) 5% to 10% by volume of a composition of 94-96% by weight Al₂O₃, 0.45% by weight Na₂O, 0.015% by weight Fe₂O₃, 0.020% by weight SiO₂ and 0.002% by weight TiO₂, and, iv) 50% to 65% by volume of Fuller's Earth. Optionally, each ingredient forms a layer in a predefined sequence of layers i) through iv).

There is further provided in accordance with an exemplary embodiment of the invention an apparatus for rehabilitating fluidic substances, comprising: a rehabilitation section containing therein a composition of matter according to any one of exemplary embodiments described above. In an embodiment of the invention, the apparatus further comprises at least one of an electromagnetic filtration section or a universal particle filtration section. Optionally, the rehabilitation section is comprised of at least one rehabilitation vessel. Optionally, the rehabilitation vessel is adapted for flow of the fluidic substances therethrough. Optionally, the rehabilitation vessel contains the composition of matter. Optionally, the rehabilitation vessel is a rehabilitation rod. Optionally, the electromagnetic filtration section is comprised of at least one electromagnetic probe which, when charged, attracts metallic particles. Optionally, the universal particle filtration section is comprised of a conical baffle assembly provided with a filtration screen which collects particles within the screen. Optionally, the electromagnetic filtration section and the universal particle filtration section are combined in a single section. Optionally, the fluidic substances being rehabilitated flow through at least one of the electromagnetic filtration section or the universal particle filtration section prior to flowing through the rehabilitation section. Optionally, the fluidic substances being rehabilitated are recirculated through at least one of the electromagnetic filtration section or the universal particle filtration section and the rehabilitation section.

There is further provided in accordance with an exemplary embodiment of the invention a universal particle filtration section for filtering particles from a fluidic substance passing therethrough, comprising: an upstream portion adjacent to an inlet to the universal particle filtration section; and, a downstream portion adjacent to an outlet of the universal particle filtration section, wherein the upstream and downstream portions are divided by a conical baffle assembly. Optionally, the conical baffle assembly is provided with pores for filtering particles larger than 5 microns in diameter. Optionally, the conical baffle assembly is provided with pores for filtering particles larger than 1 micron in diameter. Optionally, the conical baffle assembly is provided with pores for filtering particles larger than 0.5 microns in diameter.

There is further provided in accordance with an exemplary embodiment of the invention method for rehabilitating at least one fluidic substance, comprising: passing the at least one fluidic substance through a composition of matter according to any one of exemplary embodiments described above. In an embodiment of the invention, the method further comprises passing the at least one fluidic substance through an electromagnetic filter for filtering out metallic debris. In an embodiment of the invention, the method further comprises passing the at least one fluidic substance through a universal filter for filtering out debris greater than a certain size. In an embodiment of the invention, the method further comprises selecting at least one of: i) ingredients for the composition of matter, ii) the proportions of the ingredients, or iii) the sequence of the ingredients; based on the type of fluidic substance being rehabilitated. Optionally, type is defined by viscosity. Optionally, type is defined by pH. Optionally, type is defined by the kind of fluid being rehabilitated. Optionally, kind is selected from a group comprising lubricating fluids, hydraulic fluids, petroleum products, water, refrigerant or coolant fluids.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE FIGURES

Non-limiting embodiments of the invention will be described with reference to the following description of exemplary embodiments, in conjunction with the Figures. The Figures are generally not shown to scale and any measurements are only meant to be exemplary and not necessarily limiting. In the Figures, identical structures, elements or parts which appear in more than one Figure are preferably labeled with a same or similar number in all the Figures in which they appear, in which:

FIG. 1 is a block diagram showing generally the sections of an apparatus for rehabilitating fluidic substances, in accordance with an exemplary embodiment of the invention;

FIG. 2A is a cross-sectional view of an electro-magnetic particle filtration section, in accordance with an exemplary embodiment of the invention;

FIG. 2B is a perspective view of a base of an electro-magnetic particle filtration section, in accordance with an exemplary embodiment of the invention;

FIG. 3 is a perspective view of a universal particle filtration section, including a conical baffle assembly, in accordance with an exemplary embodiment of the invention;

FIG. 4 is a cross-sectional view of universal particle filtration section, including a conical shaped baffle/filter, in accordance with an exemplary embodiment of the invention;

FIG. 5 is a cross-sectional view of a rehabilitation section, in accordance with an exemplary embodiment of the invention;

FIG. 6 is a perspective view of a rehabilitation rod, in accordance with an exemplary embodiment of the invention;

FIG. 7A is a schematic view of ingredient layering for rehabilitating fluids with ISO viscosity grades between 2 and 15 at 40° C., in accordance with an exemplary embodiment of the invention;

FIG. 7B is a schematic view of ingredient layering for rehabilitating fluids with ISO viscosity grades between 22 and 460 at 40° C., in accordance with an exemplary embodiment of the invention;

FIG. 7C is a schematic view of ingredient layering for rehabilitating fluids with ISO viscosity grades greater than 460 at 40° C., in accordance with an exemplary embodiment of the invention; and,

FIG. 8 is a flowchart of a method for rehabilitating at least one fluidic substance, in accordance with an exemplary embodiment of the invention.

### DETAILED DESCRIPTION OF EXEMPLARY EMBODIMENTS

In some embodiments of the invention, a composition of matter and/or a plurality of compositions of matter are selected to be used for the rehabilitation of a fluidic substance. The fluidic substance is petroleum based, in some embodiments of the invention. In some embodiments of the invention, the fluidic substance is a refrigerant and/or coolant. In some embodiments of the invention, the fluidic substance is de-ionized water and/or some other non-conducting fluid.

As used in this application, rehabilitation generally means returning at least one desired property of the fluidic substance to a pre-used level, for example fluidic substances are rehabilitated to restore their purity in some embodiments of the invention. In some embodiments of the invention, the viscosity of the fluidic substance is altered by removing moisture. In some embodiments of the invention, the acidity of the fluidic substance is altered by removing particles from the substance. In some embodiments of the invention, the color of the fluidic substance is changed by removing particles from the fluid and/or altering the dielectric properties of the fluid. In some embodiments of the invention, rehabilitation using the herein described compositions of matter improves at least one property to and/or above its pre-use level, indicating the possible utility of these compositions as a final step in the original processing of the fluidic substance.

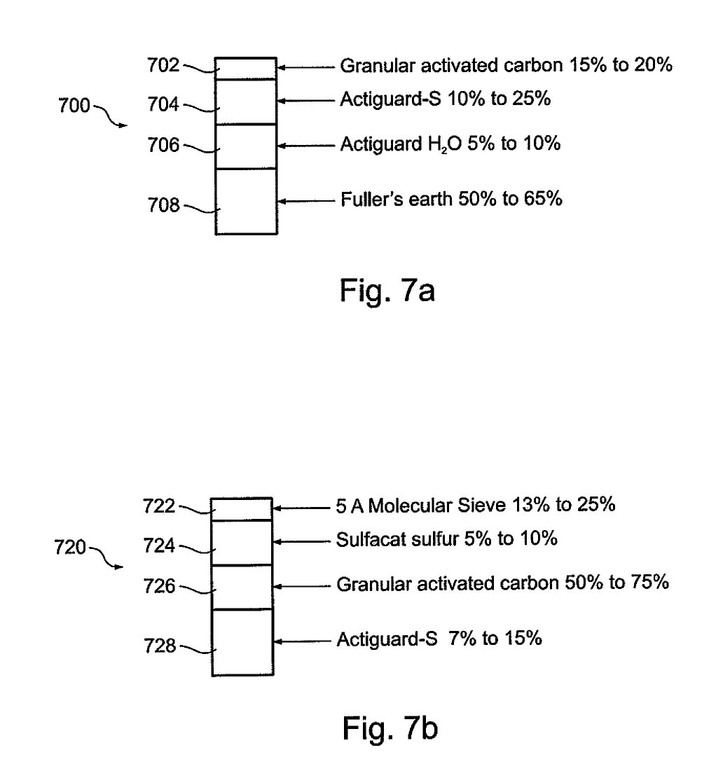

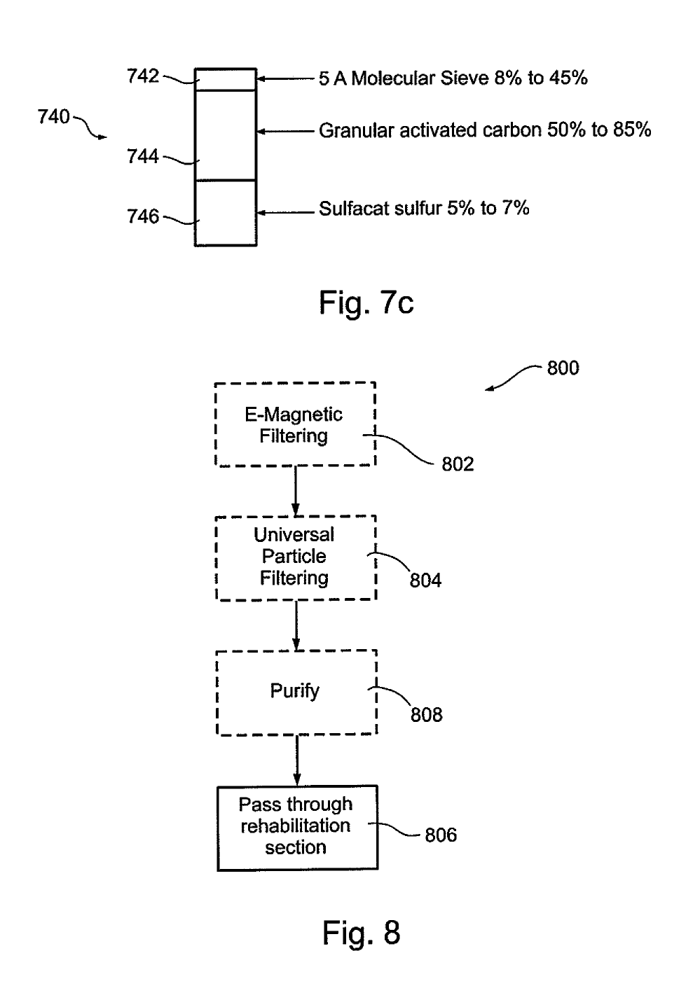

In an embodiment of the invention, a composition of matter is comprised of selected and herein described ingredients. In an embodiment of the invention, ingredients are layered in a pre-defined order, for example as shown in FIGS. 7A-C, whereby the fluidic substance being rehabilitated is passed through the layers in sequence. In some embodiments of the invention, each ingredient is selected to perform a different effect on the fluidic substance being rehabilitated, examples including reducing acidity, as a desiccant, and/or for removing sulfur. In some embodiments of the invention, a plurality of ingredients are used to provide a cumulative effect on the fluidic substance, for example continuing to reduce acidity as the fluid passes through the plurality of layers of ingredients. In some embodiments of the invention, ingredient layers are chosen and placed in order using a determining factor such as molecular weight of the respective ingredients. Optionally, at least one of the ingredients is itself a composition of a plurality of components.

In some embodiments of the invention, ingredients include Fuller's Earth, granular activated carbon, 5A molecular sieve beads, a sulfur scavenger such as Alcan Actiguard S, a desiccant such as Alcan Actiguard H₂O, and/or an adsorbent designed to remove sulfur compounds from streams that do not contain oxygen, such as Sulfurcat.

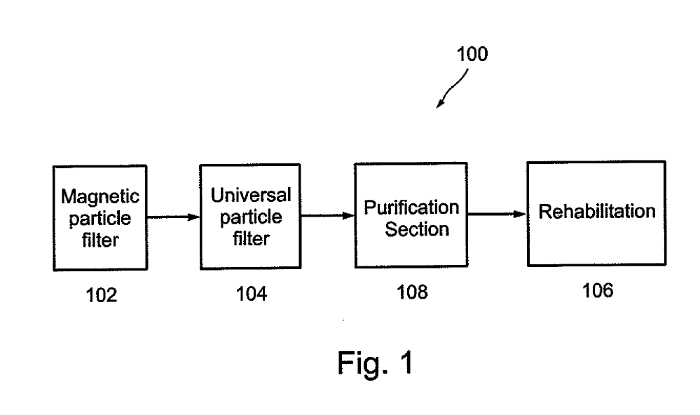

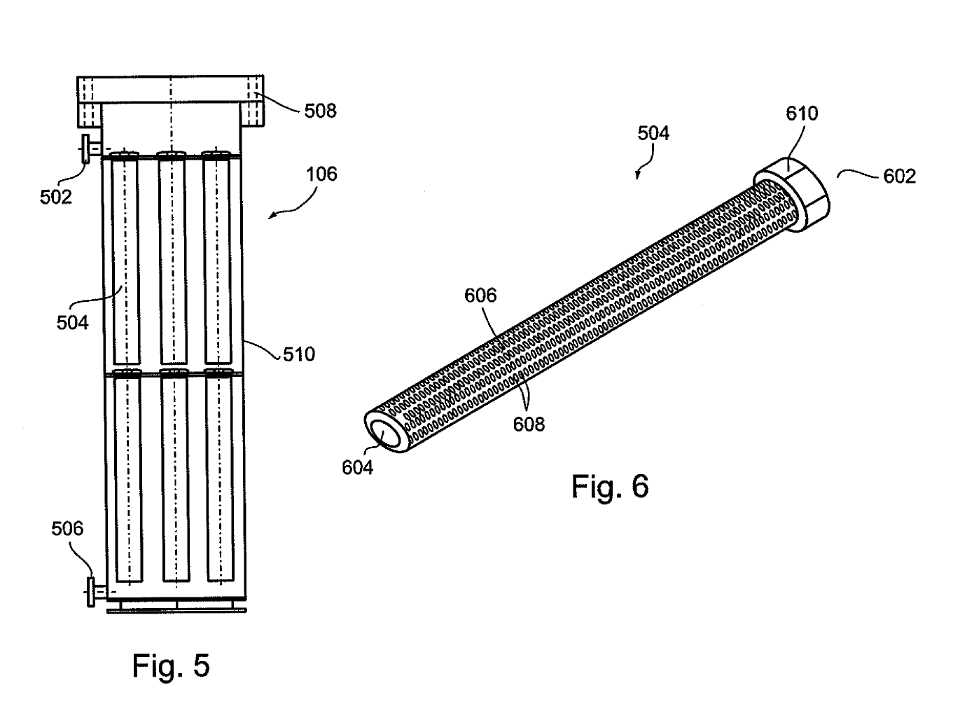

In an embodiment of the invention, selected ingredients are presented (e.g. the fluidic substance flows through the ingredients) to the fluidic substance being rehabilitated in a specific order, for example granular activated carbon preceding Actiguard S in the direction of flow of the fluidic substance. In some embodiments of the invention, the ingredients are layered in at least one vessel in the specific order wherein the fluidic substance is passed through the at least one vessel, and therefore the layers, in a desired sequence of exposure to the layers of ingredients. Optionally, the at least one vessel is a cylindrical rod, such as the rehabilitation rod described with respect to FIGS. 5 and 6. Additionally, alternatively and/or optionally, the at least one vessel is porous. In some embodiments of the invention, the ingredients are used in a rehabilitation apparatus, an example of which is shown schematically in FIG. 1.

In some embodiments of the invention, the proportion of the total amount and/or selection of ingredients are dependent on the type fluidic substance being rehabilitated. Type is determined, for example, by ISO Viscosity Grade and/or the kind of fluid (e.g. lubricating, hydraulic, and/or other petroleum products, water, refrigerant and/or coolant fluids, etc.) and/or the pH of the fluid being rehabilitated.

In general, the dirtier a fluid being rehabilitated is the more total amount of ingredients that need to be used in order to rehabilitate the fluid. In some embodiments of the invention, 5,000 kg of ingredients is used to rehabilitate approximately 100,000 L of fluid.

Before explaining at least one embodiment of the invention in detail, it is to be understood that the invention is not necessarily limited in its application to the details of construction and the arrangement of the components and/or methods set forth in the following description and/or illustrated in the drawings and/or the exemplary embodiments. The invention is capable of other embodiments or of being practiced or carried out in various ways.

FIG. 1 is a block diagram showing generally the sections of an apparatus 100 for rehabilitating fluidic substances, in accordance with an exemplary embodiment of the invention. In an embodiment of the invention, apparatus 100 is comprised of a rehabilitation section 106. Additionally, alternatively and/or optionally, apparatus 100 is provided with an electro-magnetic particle filtration section 102 and/or a universal particle filtration section 104 and/or a purification section 108.

In an embodiment of the invention, rehabilitation section 106 is comprised of at least one vessel (an example shown in more detail with respect to FIG. 5) with the ingredients situated therein wherein the fluidic substance being rehabilitated flows into the at least one vessel, through the ingredients and/or is recirculated through the ingredients until the fluidic substance has been rehabilitated to or above a predetermined threshold, for example a threshold of quality. Optionally, the ingredients are arranged in a porous, cylindrical rod, such as the rehabilitation rod described with respect to FIGS. 5 and 6. In some embodiments of the invention, a plurality of vessels, each containing at least one of the ingredients, is used for rehabilitating the fluid passing therethrough. Optionally, the plurality of vessels is arranged in a predefined sequence.

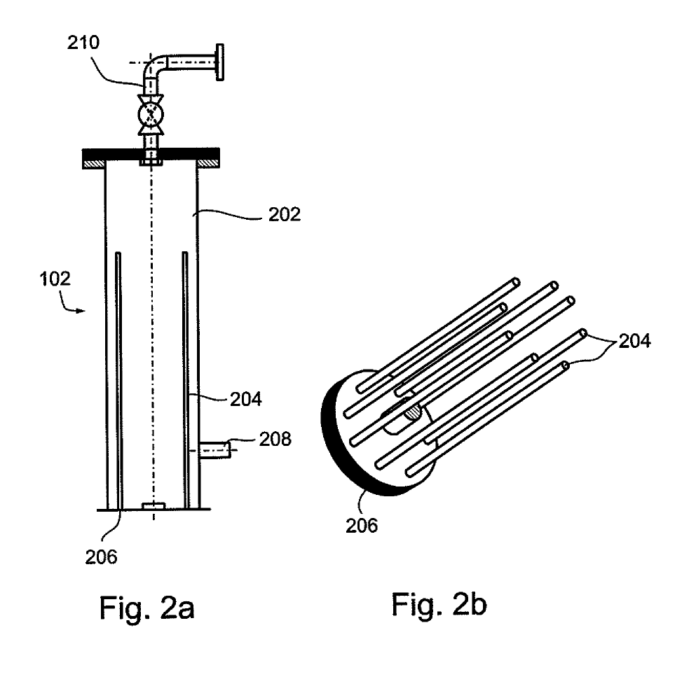

In an embodiment of the invention, electro-magnetic particle “filtration” section 102 is used to remove metallic debris and metallic particles from the fluidic substance being rehabilitated. Electro-magnetic particle “filtration” section 102 is actually comprised of an electromagnetic probe which, when charged, attracts metallic particle, in an embodiment of the invention. Electro-magnetic particle “filtration” section 102 is described in more detail with respect to FIGS. 2A-B.

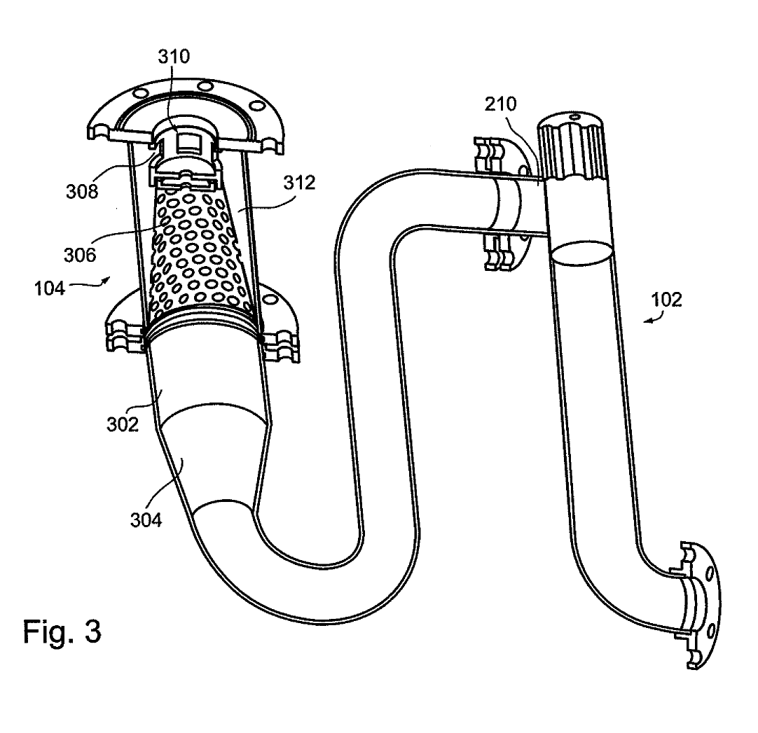

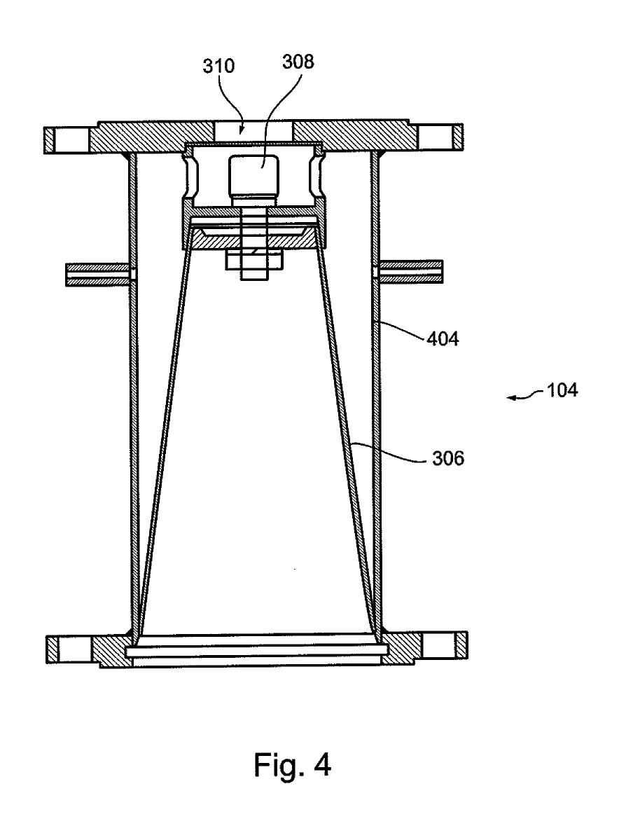

In some embodiments of the invention, universal particle filtration section 104 is used to collect both metallic and non-metallic particle based on particle shape and/or size. In an embodiment of the invention, universal particle filtration section 104 is comprised of a conical baffle assembly provided with a filtration screen which collects particles within the screen. Universal particle filtration section 104 is described in more detail with respect to FIGS. 3 and 4.

In some embodiments of the invention, sections 102, 104, 106 and/or 108 are sized to enable efficient flow through apparatus. Optionally, apparatus 100 is portable for use in a plurality of locations. In some embodiments of the invention, at least two of sections 102, 104 and/or 108 are combined into one section. Additionally, alternatively and/or optionally, sections 102, 104 and/or 108 do not necessarily need to be arranged in a specific order.

Referring to FIG. 2A, a cross-sectional view of electro-magnetic particle filtration section 102 is shown, in accordance with an exemplary embodiment of the invention. Electro-magnetic particle filtration section 102 is provided with an EM section housing 202 which is adapted for flow of the fluidic substance therethrough and/or for the safe operation of the electro-magnetic features of the electro-magnetic particle filtration section 102, in an embodiment of the invention. An inlet 208 and/or an outlet 210 are provided to EM section housing 202 for the introduction and removal of the fluidic substance being rehabilitated. In some embodiments of the invention, at least one magnetic probe 204 is used to attract metallic particles when charged. As seen in more detail in FIG. 2B, the at least one magnetic probe 204 is fastened to an EM section housing base plate 206. In an embodiment of the invention, the fluidic substance being rehabilitated enters electro-magnetic particle filtration section 102 at inlet 208 and flows in a direction towards outlet 210, thereby passing by and/or around at least one magnetic probe 204. At least one magnetic probe 204 is optionally selectively provided with current in order to activate and/or deactivate its magnetic property for attracting metallic particles in the fluidic substance. In an embodiment of the invention, metallic particles are attracted to the at least one magnetic probe 204 and “stick” to probe 204 as a result of the magnetic attraction between the metallic particles and probe 204. In some embodiments of the invention, operation of apparatus 100 is halted temporarily in order to remove at least one magnetic probe 204 for removal of the metallic particles adhered thereto.

It should be understood that while the present application describes an electromagnetic particle filtration section, it is by way of example only, and that any solution known to those skilled in the art are useable to remove metallic particles from the fluidic substance being rehabilitated.

FIG. 3 is a perspective view of universal particle filtration section 104 downstream from electro-magnetic particle filtration section 102, in accordance with an exemplary embodiment of the invention. It should be understood that in apparatus 100, the order of the two sections 102, 104 and/or rehabilitation section 106, described in more detail below, could be switched and/or could optionally include less or more of each type of section. In some embodiments of the invention, the universal particle filtration section 104 is adapted for regulating fluid flow and/or filtering debris.

The fluidic substance enters universal particle filtration section 104 at an inlet 304, which is optionally shaped to control the flow rate of the fluidic substance and/or to control debris which collects as a result of the filtration which occurs in section 104, in an embodiment of the invention. In an embodiment of the invention, universal particle filtration section 104 is provided with a conical shaped baffle 306 which also serves as a filter for removing debris from the fluid being rehabilitated. In an embodiment of the invention, universal particle filtration section 104 is divided into a downstream portion 312 which is downstream of conical shaped filter/baffle 306 and an upstream portion 302 which is upstream of conical shaped filter/baffle 306. The fluidic substance being rehabilitated is passed from upstream portion 302 through conical shaped filter/baffle 306 and into downstream portion 312 of universal particle filtration section 104.

In an embodiment of the invention, conical shaped filter/baffle 306 filters particles larger than a predefined size out of the fluidic substance. In some embodiments of the invention, the size of particles which are filtered is determined by the type of fluid being filtered, for example fluids with high ISO viscosity grades (ISO viscosity grades being one way of determining type) are filtered for particles as small as 10 microns. In some embodiments of the invention, conical shaped filter/baffle 306 is provided with pores adapted for filtering out debris as small as 5 microns. In some embodiments of the invention, conical shaped filter/baffle 306 is provided with pores adapted for filtering out debris as small as 1 micron. In some embodiments of the invention, conical shaped filter/baffle 306 is provided with pores adapted for filtering out debris as small as 0.5 microns.

In an embodiment of the invention, the conical shape of the filter/baffle 306 is used to regulate fluid flow as it transitions from electro-magnetic particle filtration section 102 to rehabilitation section 106 (described in more detail below) in fluid rehabilitation apparatus 100. In some embodiments of the invention, the flow velocity begins to slow down in section 304 and then further slowed down in upstream portion 302 as the fluid is slowed while passing through conical shaped filter/baffle 306. In some embodiments of the invention, the flow velocity in the downstream portion 312 increases as the fluid progresses past the baffle/filter 306 through at least one pre-outlet orifice 308 (which is optionally also adapted to regulate fluid flow) and out of universal particle filtration section 104 via outlet 310 towards rehabilitation section 106 eventually and/or purification section 108 prior to rehabilitation section 106.

In some embodiments of the invention, the viscosity of the fluid being rehabilitated, the size of the pores of the filter/baffle 306 and/or the overall internal volume of universal particle filtration section 104 and/or the design of the conical shape of the filter/baffle 306 for achieving a specific baffle effect are related and adapted for preventing backwash from universal particle filtration section 104 into electro-magnetic particle filtration section 102.

Referring to FIG. 4, a cross-sectional view of part of universal particle filtration section 104, including conical shaped filter/baffle 306, in accordance with an exemplary embodiment of the invention is shown.

Referring to FIG. 5, a cross-sectional view of rehabilitation section 106 is shown, in accordance with an exemplary embodiment of the invention. In some embodiments of the invention, rehabilitation section 106 includes a vessel 510 with a volume therein through which the fluidic substance being rehabilitated flows. At least one rehabilitation rod 504 is positioned in vessel 510 such that the fluidic substance being rehabilitated flows into vessel 510 from an inlet 502, through the at least one of the ingredient types described above and out of vessel 510 via an outlet 506, in an embodiment of the invention.

In an embodiment of the invention, at least one ingredient described above is placed in at least one rehabilitation rod 504 (an example of which is described in more detail with respect to FIG. 6), rehabilitation rod 504 located within the volume circumscribed by vessel 510. In some embodiments of the invention, a plurality of rehabilitation rod 504 is used, for example to provide a cumulative effect and/or to rehabilitate larger volumes of fluid at a time. FIG. 5 shows an exemplary embodiment of the invention in which multiple rods 504 are used in two different stages. Optionally, the ingredients and/or the proportions of ingredients are changed from stage to stage and/or amongst a plurality of rods 504. In some embodiments of the invention, rehabilitation section 106 is adapted to provide re-circulating flow to vessel 510, for example to pass the fluidic substance through the at least one rod 504 at least one more time. In some embodiments of the invention, a removably attached cover 508 is provided to vessel 510 to allow for access into the interior volume of vessel 510, for example to perform maintenance, cleaning and/or replacement of at least one rod 504.

Additionally, alternatively and/or optionally a plurality of vessels 510 are provided to rehabilitation section 106 of apparatus, for example to pass the fluidic substance from a first vessel to a second vessel and so on. It should be noted that in some embodiments of the invention, the ingredients and/or the proportions of ingredients for rods within the plurality of vessels are changed from stage to stage and/or amongst the plurality of rods 504 and/or amongst the plurality of vessels. In an embodiment of the invention, the fluidic substance is circulated through apparatus 100 until the fluidic substance has been rehabilitated to or above a predetermined threshold, for example a threshold of quality and/or purity.

FIG. 6 shows a perspective view of rehabilitation rod 504, in accordance with an exemplary embodiment of the invention. In an embodiment of the invention, rehabilitation rod 504 is adapted for the sequential arrangement of layers of ingredients used for rehabilitating the fluidic substance which passes through rod 504. In some embodiments of the invention, rehabilitation rod 504 is at least partially cylindrical, ovoid, octagonal, square, trapezoidal, rectangular and/or the like when viewed from one or both ends. In an embodiment of the invention, rehabilitation rod 504 is provided with at least one pore 608 along the outer surface 606 of rod 504, adapted for flow of the fluidic substance being rehabilitated therethrough and/or through the ingredients located therein. In an embodiment of the invention, rehabilitation rod 504 is provided with openings 602, 604 at either end of a longitudinal axis for flow of the fluidic substance into rod 504 (from opening 602) and/or out of rod 504 (for example, from opening 604), depending on the rate of flow through at least one pore 608.

In some embodiments of the invention, the length to diameter ratio of rehabilitation rod 504 is adapted for efficient rehabilitation of the fluidic substance with a length to diameter ratio intended to maximize exit (from rod 504) flow through the at least one pore 608 rather than through any of the openings 602, 604, to increase/decrease surface area of the ingredients and/or to increase/decrease the volume of fluid passing through rod 504 at any one time. Optionally, the length to diameter ratio is 9 to 1. Optionally, the length to diameter ratio is 6 to 1. In some embodiments of the invention, the length to diameter ratio is chosen depending on the type of fluidic substance being rehabilitated, for example in some embodiments where the fluid viscosity is 2-15, a 6 to 1 ratio is used, while in some embodiments where the fluid viscosity is at least 22, a 9 to 1 ratio is used. In some embodiments of the invention, the overall dimensions of rehabilitation rod 504 are changed while maintaining the length to diameter ratio. In some embodiments of the invention, flow rates through rehabilitation rod 504 and/or the number of passes through rehabilitation section 106 can be adjusted by modifying the dimensions of rehabilitation rod 504, for example by increasing the ratio of ingredient surface area per volume of fluid passing through the rod the number of passes is optionally reduced.

In an embodiment of the invention, rehabilitation rod 504 is constructed of a substance which does not react with the fluid being rehabilitated. In embodiments for rehabilitating petroleum based products, a metal is used, for example aluminum.

In some embodiments of the invention, rehabilitation rod 504 is provided with an end cap 610 which is adapted for at least one of being removable for access to the ingredients inside rod 504 or mounting rod 504 to vessel 510, for example by using end cap 610 to hang rehabilitation rod 504 from a cross bar suspending rehabilitation rod 504 vertically in rehabilitation section 106.

It should be noted, however, that a vessel containing the ingredients for rehabilitation can be situated in rehabilitation section 106 in any configuration whereby a fluid can be rehabilitated, for example horizontally, vertically or at an angle off of either. Additionally, optionally and/or alternatively, vessel 510 is adapted to provide rehabilitation to fluids passing therethrough from any angle, not just originating from the top. In an embodiment of the invention, the ingredients located within vessel 510 are layered according to the anticipated angle of entry of the fluid.

FIG. 7A is a schematic view 700 of ingredient layering for rehabilitating fluids with ISO viscosity grades between 2 and 15 at 40° C., in accordance with an exemplary embodiment of the invention. In an embodiment of the invention, an initial layer 702 is comprised of granular activated carbon. Layer 702 using granular activated carbon comprises 15%-20% of the total volume of rehabilitation rod 504. Granular activated carbon is a product which is useful in liquid phase applications involving water and other liquid purification, for example for decolorization and/or separation processes. In some embodiments of the invention, granular activated carbon is used, alternatively to or in addition to the above, for reducing the acidity of fluidic substances being rehabilitated.

A second layer 704 is provided, in some embodiments of the invention, which is comprised of Actiguard S. Actiguard S is a smooth, spherical alumina based product (comprised of 83%-94% aluminum oxide, 3%-10% sodium carbonate and 3%-7% moisture) designed specifically for removal of sulfur compounds from a wide variety of petrochemical feed stocks. Actiguard-S is designed to supplement or replace existing methods of sulfur removal in both refinery and petrochemical applications. The product will effectively and economically remove sulfur compounds including COS, H₂S, CS₂ and mercapten present in trace concentrations (up to 100 ppmv). Actiguard S is also an effective desiccant material and is capable of adsorbing water and sulfur compounds simultaneously to provide a dry, high purity feedstock suitable for polymerization. The high surface area of Actiguard S, combined with a non-toxic promoter, ensures maximum sulfur adsorption capacity and improved selectivity for sulfur adsorption compared to an un-promoted activated alumina product. Actiguard S is designed as a macro porous product to provide favorable adsorption kinetics. The high macro porosity ensures minimum mass transfer zone length and minimizes sulfur leakage through the bed. Its open pore structure also helps to prevent loss of activity due to pore blockage by coke and/or polymer compounds formed during the regeneration process. In an embodiment of the invention, layer 704 using Actiguard S comprises 10%-25% of the total volume of rehabilitation rod 504. In some embodiments of the invention, this layer is used to reduce acidity.

In an exemplary embodiment of the invention, a third layer 706 is provided which is comprised of Actiguard H₂O (constituent ingredients are 94-96% Al₂O₃, 0.45% Na₂O, 0.015% Fe₂O₃, 0.020% SiO₂ and 0.002% TiO₂, percentages by weight). Actiguard H₂O is a desiccant grade product used for the drying of organic liquids, for example jet fuel and other petroleum based fluidic substances. In an embodiment of the invention, layer 706 using Actiguard H2O comprises 5%-10% of the total volume of rehabilitation rod 504. In some embodiments of the invention, this layer is used to at least partially dehydrate the fluid being rehabilitated

In an embodiment of the invention, a fourth layer 708 is provided which is comprised of Fuller's Earth. Fuller's Earth is any non-plastic clay or claylike earthy material that can be used to decolorize, filter, and purify animal, mineral, and vegetable oils and greases. In an embodiment of the invention, these properties of Fuller's Earth are applied for the rehabilitation of fluidic substances, for example petroleum products. In an embodiment of the invention, layer 708 using Fuller's Earth comprises 50%-65% of the total volume of rehabilitation rod 504. In some embodiments of the invention, this layer is used to reduce the acidity of the fluid being rehabilitated.

In some embodiments of the invention, each layer's place in the sequence is chosen to prepare the fluid being rehabilitated for the next ingredient in the sequence, for example to alter the fluid's pH and/or moisture level prior to being acted upon by the next ingredient.

In an embodiment of the invention, the four layers 702, 704, 706, 708 are layered in a 20%, 15%, 5%, 60% proportion, respectively. Optionally, this exemplary layering scheme is used in combination with rehabilitation rod 504, wherein first layer 702 is located in rod 504 proximal to end cap 610 and fourth layer 708 is located in rod 504 most distal from end cap 610, near opening 604. In an embodiment of the invention, the fluid being rehabilitated enters rod 504 through opening 602, which traverses end cap 610 and then is passed through at least one pore 608 and possibly opening 604. In so doing, the fluidic substance is acted upon by the ingredients serving to at least partially rehabilitate the fluidic substance. As described above, in some embodiments of the invention, the fluidic substance is passed through a plurality of rods 504 and/or a single rod 504 to further rehabilitate the fluidic substance.

FIG. 7B is a schematic view 720 of ingredient layering for rehabilitation of fluids with ISO viscosity grades between 22 and 460 at 40° C., in accordance with an exemplary embodiment of the invention. A first layer 722 is comprised of a 5A molecular sieve, in an embodiment of the invention. 5A molecular sieves are mainly applied in industry to separate out isoalkanes. First layer 722 5A molecular sieve has high capacity for decolorizing the fluid, among other uses. In an embodiment of the invention, layer 722 adsorbs C₃-C₄ alkane isomers, ethane chloride, ethane bromide, and/or butanol. In an embodiment of the invention, layer 722 using the 5A molecular sieve comprises 13%-25% of the total volume of rehabilitation rod 504. In some embodiments of the invention, this layer is used to reduce acidity and/or discoloring of the fluid being rehabilitated.

It should be noted that ingredients used and/or layering is adapted to the viscosity of the fluid being rehabilitated, in some embodiments of the invention. For example, in an embodiment described above for ISO viscosity grades 2 to 15, a combination of granular activated carbon and Fuller's Earth (see FIG. 7A) is used to decolorize petroleum based fluids during rehabilitation while a combination of granular activated carbon and a 5A molecular sieve layer is instead used in other selected embodiments (described below, see FIGS. 7B, 7C), for example to account for the dielectric nature of higher viscosity embodiments.

In an embodiment of the invention, a second layer 724 is comprised of Sulfurcat. Sulfurcat is a composition of 52%-58% Ni and 42%-48% Al₂O₃. This adsorbent is used in some embodiments of the invention, for removing H₂S, CS₂, light mercapten, t-Butyl mercaptan, sulfides, disulfides, and H₂Se (hydrogen selenide). In an embodiment of the invention, layer 722 using the Sulfurcat comprises 5%-10% of the total volume of rehabilitation rod 504. In some embodiments of the invention, this layer is used to reduce sulfur levels in the fluid being rehabilitated by trapping sulfur containing substances as the fluid passes through it.

In an embodiment of the invention, a third layer 726 is comprised of granular activated carbon. The granular activated carbon comprises 50%-75% of the total volume of rehabilitation rod 504, in some embodiments of the invention. In some embodiments of the invention, this layer is used for decolorization and/or separation processes. In some embodiments of the invention, granular activated carbon is used, alternatively to or in addition to the above, for reducing the acidity of fluidic substances being rehabilitated.

In an embodiment of the invention, a fourth layer 728 is comprised of Actiguard S which accounts for 7%-15% of the total volume of rehabilitation rod 504.

In an embodiment of the invention, the four layers 722, 724, 726, 728 are layered in a 18%, 5%, 70%, 7% proportion, respectively. Optionally, this exemplary layering scheme is used in combination with rehabilitation rod 504.

FIG. 7C is a schematic view 740 of ingredient layering for rehabilitation of fluids with ISO viscosity grades greater than 460 at 40° C., in accordance with an exemplary embodiment of the invention. In an embodiment of the invention, a first layer 742 comprised of a 5A molecular sieve is provided. In some embodiments of the invention, the 5A molecular sieve comprises 8%-45% of the total volume of rehabilitation rod 504.

In an embodiment of the invention, a second layer 744 is comprised of granular activated carbon. The granular activated carbon comprises 50%-85% of the total volume of rehabilitation rod 504, in some embodiments of the invention.

In an embodiment of the invention, a third layer 744 is comprised of Sulfurcat. In an embodiment of the invention, layer 744 using the Sulfurcat comprises 5%-7% of the total volume of rehabilitation rod 504.

In an embodiment of the invention, the three layers 742, 744, 746, are layered in a 15%, 80%, 5% proportion, respectively. Optionally, this exemplary layering scheme is used in combination with rehabilitation rod 504.

It should be understood that the embodiments described above are not necessarily limited to the specific proportions and/or ingredient orders in order to have at least some beneficial effect on the fluid being rehabilitated. In some embodiments, the ingredients are not layered and/or are not in a specific order and/or are mixed.

FIG. 8 is a flowchart 800 of a method for rehabilitating at least one fluidic substance, in accordance with an exemplary embodiment of the invention. In an embodiment of the invention, a fluid being rehabilitated is passed (806) through layers of ingredients according to a predefined sequence. Examples of ingredients and/or predefined sequences are described with respect to FIGS. 7A-7C and elsewhere within this application. Additionally and/or optionally, the fluidic substance is filtered (802) using an electromagnetic filter, for example electro-magnetic particle filtration section 102 described with respect to FIGS. 2A and 2B and elsewhere herein. Additionally and/or optionally, the fluidic substance is filtered (804) using a universal (magnetic and/or non-magnetic) particle filter, for example universal particle filtration section 104 described with respect to FIGS. 3 and 4 and elsewhere herein. Additionally, alternatively and/or optionally, the fluidic substance is purified (808) for removing particulate debris, gas and/or moisture prior to passage (806) through rehabilitation section 106.

In some embodiments of the invention, one or more of (802), (804), (806), (808) are repeated during the rehabilitation of the fluidic substance. Optionally, (802), (804), (806), (808) are not necessarily in the order shown in FIG. 8, for example (804) can occur prior to (802). In some embodiments of the invention, repeated actions are not performed by the same physical component, for example repeated filtration and/or passage through the rehabilitation may not be through the same filtration section and/or rehabilitation section.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

The terms “comprises”, “comprising”, “includes”, “including”, “having” and their conjugates mean “including but not limited to”. This term encompasses the terms “consisting of” and “consisting essentially of”. The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The scope of the invention is limited only by the following claims.

1. A composition of matter for rehabilitating a fluidic substance, comprising:
a) at least one decolorizing ingredient constituting at least 58% by volume of the whole composition; and,
b) at least one acidity reducing ingredient constituting at least 5% by volume of the whole composition.

2. A composition of matter according to claim 1, further comprising:
c) at least one dehydrating ingredient constituting at least 5% by volume of the whole composition.

3. A composition of matter according to claim 1 or claim 2, wherein the at least one decolorizing ingredient is at least one of: i) Fuller's Earth, ii) a 5A molecular sieve or iii) granular activated carbon.

4. A composition of matter according to any of claims 1-3, where the at least one acidity reducing ingredient is at least one of: i) a composition of 83%-94% aluminum oxide, 3%-10% sodium carbonate and 3%-7% moisture, ii) Fuller's Earth, or iii) a 5A molecular sieve.

5. A composition of matter according to claim 2, wherein the at least one dehydrating ingredient is at least one of: i) a composition of 94-96% by weight Al₂O₃, 0.45% by weight Na₂O, 0.015% by weight Fe₂O₃, 0.020% by weight SiO₂ and 0.002% by weight TiO₂, or ii) a composition of 83%-94% aluminum oxide, 3%-10% sodium carbonate and 3%-7% moisture.

6. A composition of matter according to any of claims 1-5, wherein the at least one decolorizing agent is either a combination of Fuller's Earth and granular activated carbon for fluid viscosities less than or equal to ISO 15 or a combination of granular activated carbon and a 5A molecular sieve for fluid viscosities greater than ISO 15.

7. A composition of matter according to any of claims 1-6, comprising:
i) 13% to 25% by volume of a 5A molecular sieve,
ii) 5% to 10% by volume of a composition of 52%-58% Ni and 42%-48% Al₂O₃;
iii) 50% to 75% by volume of granular activated carbon, and,
iv) 7% to 15% by volume of a composition of 83%-94% aluminum oxide, 3%-10% sodium carbonate and 3%-7% moisture.

8. A composition of matter according to any of claims 1-6, comprising:
i) 8% to 45% by volume of a 5A molecular sieve,
ii) 50% to 85% by volume of granular activated carbon, and,
iii) 5% to 7% by volume of a composition of 52%-58% Ni and 42%-48% Al₂O₃.

9. A composition of matter according to any of claims 2-6, comprising:
i) 15% to 20% by volume of granular activated carbon,
ii) 10% to 25% by volume of a composition of 83%-94% aluminum oxide, 3%-10% sodium carbonate and 3%-7% moisture;
iii) 5% to 10% by volume of a composition of 94-96% by weight Al₂O₃, 0.45% by weight Na₂O, 0.015% by weight Fe₂O₃, 0.020% by weight SiO₂ and 0.002% by weight TiO₂, and,
iv) 50% to 65% by volume of Fuller's Earth.

10. A composition of matter according to claim 7, wherein each ingredient forms a layer in a predefined sequence of layers i) through iv).

11. A composition of matter according to claim 8, wherein each ingredient forms a layer in a predefined sequence of layers i) through iii).

12. A composition of matter according to claim 9, wherein each ingredient forms a layer in a predefined sequence of layers i) through iv).

13. An apparatus for rehabilitating fluidic substances, comprising:
a rehabilitation section containing therein a composition of matter according to any one of claims 1-12.

14. An apparatus according to claim 13, further comprising at least one of an electromagnetic filtration section or a universal particle filtration section.

15. An apparatus according to claim 13 or claim 14, wherein the rehabilitation section is comprised of at least one rehabilitation vessel.

16. An apparatus according to claim 15, where the rehabilitation vessel is adapted for flow of the fluidic substances therethrough.

17. An apparatus according to claim 16, wherein the rehabilitation vessel contains the composition of matter.

18. An apparatus according to claim 16 or claim 17, wherein the rehabilitation vessel is a rehabilitation rod.

19. An apparatus according to claim 14, wherein the electromagnetic filtration section is comprised of at least one electromagnetic probe which, when charged, attracts metallic particles.

20. An apparatus according to claim 14, wherein the universal particle filtration section is comprised of a conical baffle assembly provided with a filtration screen which collects particles within the screen.

21. An apparatus according to claim 14, wherein the electromagnetic filtration section and the universal particle filtration section are combined in a single section.

22. An apparatus according to claim 14, wherein the fluidic substances being rehabilitated flow through at least one of the electromagnetic filtration section or the universal particle filtration section prior to flowing through the rehabilitation section.

23. An apparatus according to claim 22, wherein the fluidic substances being rehabilitated are recirculated through at least one of the electromagnetic filtration section or the universal particle filtration section and the rehabilitation section.

24. A universal particle filtration section for filtering particles from a fluidic substance passing therethrough, comprising:
an upstream portion adjacent to an inlet to the universal particle filtration section; and,
a downstream portion adjacent to an outlet of the universal particle filtration section,
wherein the upstream and downstream portions are divided by a conical baffle assembly.

25. A universal particle filtration section according to claim 24, wherein the conical baffle assembly is provided with pores for filtering particles larger than 0.5 microns in diameter.

26. A universal particle filtration section according to claim 24, wherein the conical baffle assembly is provided with pores for filtering particles larger than 1 micron in diameter.

27. A universal particle filtration section according to claim 24, wherein the conical baffle assembly is provided with pores for filtering particles larger than 5 microns in diameter.

28. A method for rehabilitating at least one fluidic substance, comprising:
passing the at least one fluidic substance through a composition of matter according to any one of claims 1-12.

29. The method according to claim 28, further comprising passing the at least one fluidic substance through an electromagnetic filter for filtering out metallic debris.

30. The method according to claim 28 or claim 29, further comprising passing the at least one fluidic substance through a universal filter for filtering out debris greater than a certain size.

31. The method according to any of claims 28-30, further comprising selecting at least one of: i) ingredients for the composition of matter, ii) the proportions of the ingredients, or iii) the sequence of the ingredients; based on the type of fluidic substance being rehabilitated.

32. The method according to claim 31, wherein type is defined by viscosity.

33. The method according to claim 31, wherein type is defined by pH.

34. The method according to claim 31, wherein type is defined by the kind of fluid being rehabilitated.

35. The method according to claim 34, wherein kind is selected from a group comprising lubricating fluids, hydraulic fluids, petroleum products, water, refrigerant or coolant fluids.
